(19) United States
(12) Patent Application Publication
(10) Pub. No.: US 2023/0319376 A1
(43) Pub. Date: Oct. 5, 2023

(54) DISPLAY DEVICE AND OPERATING METHOD THEREOF

(71) Applicant: LG ELECTRONICS INC., Seoul (KR)

(72) Inventors: Huisang YOO, Seoul (KR); Youngwook KANG, Seoul (KR)

(73) Assignee: LG ELECTRONICS INC., Seoul (KR)

(21) Appl. No.: 18/012,210

(22) PCT Filed: Jun. 22, 2021
(86) PCT No.: PCT/KR2021/007794

§ 371 Date: Dec. 21, 2022

(30) Foreign Application Priority Data
Jun. 22, 2020 (KR) 10-2020-0075867

(51) Int. Cl. H04N 21/8549; G06V 20/40; H04N 21/466; H04N 21/454; H04N 21/472

(52) U.S. Cl. CPC H04N 21/8549; G06V 20/47; G06V 20/44; H04N 21/4668; H04N 21/454; H04N 21/472

(57) ABSTRACT

A display device according to an embodiment of the present disclosure can generate and provide summarized content by selecting a user's favorite content based on a user viewing history and processing the selected favorite content to suit a user preference. The display device includes a controller configured to acquire user preference, and a display configured to display summarized content generated based on the user preference. The controller can be configured to extract some frames from original content based on the user preference, and to generate summarized content including the extracted frames.

### TECHNICAL FIELD

The present disclosure relates to a display device and an operating method thereof.

### BACKGROUND ART

With the development of the Internet, an infrastructure that allows anyone to easily search for content and consume content has been prepared. With the popularization of mobile devices, people can consume media content free from the restrictions of place. In these changes, people's desire/propensity to consume content by spending only as much time as they want within the available time has increased. As a result, there have also been significant changes in media consumption patterns. People tend to avoid long videos due to problems such as lack of time and attention. Even when consuming media content, there is a growing desire to reduce unnecessary time wasted due to viewing unwanted content and to consume media by using leftover time.

This change in media consumption patterns has also affected the content production field, and a new type of content called short content has emerged. For example, TikTok, YouTube, and the like provided a series of processes of creating/distributing/consuming content as a service, leading to an explosive increase in short content. When the personal media industry is being reorganized around short content, original content producers such as broadcasting stations are joining the trend of the times in line with this trend by starting a clip-type media service that provides short summarized contents of previously produced long-form media content.

On the other hand, in the age of exponentially increasing media content, there is an advantage in that users can experience and select a variety of media content. However, there occurs a problem that spends a lot of time or has difficulty in finding desired content among too many contents. To solve these difficulties, real-time broadcasting services centered on broadcast-based broadcasting stations provide additional services such as program guides and reserved viewing services. Broadband-based OTT services such as Netflix and YouTube provide user-friendly services such as advanced search techniques and recommendation services.

However, the program guides and reservation viewing services in the broadcast area have the inconvenience of requiring users to find and set their favorite content. The search/recommendation services in the broadband area is inconvenient in that an additional selection process is required to select content that suits one's taste among many and diverse types of content presented as a result of the search/recommendation.

In addition, in the case of series, when a new series is distributed, if a user does not remember contents of the previous series well, there is the inconvenience of having to watch the previous series again. In the case of sports or news content, some users want to watch only the main scenes or news rather than watching the entire content for a long time. In the current systems, it is inconvenient for the users to directly search for the edited video or to manually manipulate (for example, fast forward) to view the edited video.

In addition, conventional summarized content services have a problem in that a producer producing summarized content and consumers consuming the summarized content cannot be efficiently connected to each other. Currently, most summarized content is produced by broadcasting stations or individuals and is distributed through broadcasting stations' own platforms or YouTube. Therefore, when there is desired content, the user has to directly search for and enjoy the desired content from a specific application or website. For example, when a user who enjoys sports on TV wants to see summarized content of today's game, it requires a cumbersome process of searching for related content on the Internet or YouTube, etc., and selecting and viewing appropriate summarized content from among the search results.

### DISCLOSURE OF INVENTION

### Technical Problem

The present disclosure aims to provide a display device, which solves the above problems or inconveniences, and an operating method thereof.

The present disclosure aims to provide summarized content acquired by summarizing a broadcast program, an OTT-based video, or the like.

The present disclosure aims to provide summarized content summarized with a user's favorite images in specific content.

The present disclosure aims to provide a display device for recommending summarized content at an appropriate timing in consideration of at least one of a user viewing pattern or a user viewing situation, and an operating method thereof.

### Technical Solution

A display device according to an embodiment of the present disclosure can generate and provide summarized content by selecting a user's favorite content based on a user viewing history and processing the selected favorite content to suit a user preference.

A display device according to an embodiment of the present disclosure can acquire a recommendation timing of customized summarized content based on at least one of a user viewing pattern or a user's current viewing situation.

A display device according to an embodiment of the present disclosure can include a controller configured to acquire user preference, and a display configured to display summarized content generated based on the user preference, wherein the controller can be configured to extract some frames from original content based on the user preference, and to generate summarized content including the extracted frames.

When the controller receives a user input of changing a channel, the controller can be configured to acquire a recommendation timing of the summarized content based on the user input.

When content displayed on the channel changed according to the user input is a user's favorite content, the controller can be configured to recommend the summarized content.

The controller can be configured to recommend summarized content associated with content displayed on the channel changed according to the user input.

When a sports game is being broadcast on the changed channel, the controller can be configured to recommend summarized content acquired by summarizing previous content of the sports game being broadcast.

When news is being broadcast on the changed channel, the controller can be configured to recommend summarized content acquired by summarizing latest news.

The controller can be configured to recommend summarized content of the same content as the content displayed on the changed channel, content with the same genre as the content displayed on the changed channel, or content with the same person as the content displayed on the changed channel.

When the user input is re-received within a predetermined time after receiving the user input, the controller can be configured to recommend the summarized content.

The controller can be configured to acquire the recommendation timing according to whether user history information necessary for acquiring the user preference is stored in a storage in a predetermined reference size or more.

When the controller does not recommend the summarized content, the controller can be configured to learn the user preference based on information about content displayed according to the user input.

The controller may be configured to update the user preference based on whether the user views the summarized content.

The controller can be configured to extract a frame to be included in the summarized content from the original content based on an attention mechanism.

The controller can be configured to segment a frame of the original content into predetermined units, to extract a feature value for each segmented unit, to predict an importance score for the extracted feature value, and to extract the frame to be included in the summarized content.

The controller can be configured to extract the feature value according to whether an event occurs in each segmented unit.

The controller can be configured to detect a change in person, space or time to acquire whether the event occurs.

### Advantageous Effects

According to an embodiment of the present disclosure, since specific content is provided as summarized content summarized with a user's favorite frames, the user does not have to individually search for the specific content or search for contents to be found in the specific content. Accordingly, there is an advantage in that user convenience is greatly improved.

According to an embodiment of the present disclosure, since summarized content is provided by recognizing a user viewing situation and acquiring a recommendation timing, there is an advantage of increasing accessibility to summarized content.

According to an embodiment of the present disclosure, since the user preference is updated according to whether the user views the summarized content, there is an advantage in that the summarized content is continuously further improved in a user-customized manner.

### BRIEF DESCRIPTION OF DRAWINGS

FIG. 1 is a block diagram showing a configuration of a display device according to an embodiment of the present disclosure.

FIG. 2 is a block diagram of a remote control device according to an embodiment of the present disclosure.

FIG. 3 shows an actual configuration example of a remote control device according to an embodiment of the present disclosure.

FIG. 4 shows an example of using a remote control device according to an embodiment of the present disclosure.

FIG. 5 is a block diagram showing a configuration for a display device to provide summarized content, according to an embodiment of the present disclosure.

FIG. 6 is a flowchart showing a method by which a display device provides summarized content, according to an embodiment of the present disclosure.

FIG. 7 is a diagram schematically showing a technology by which a display device generates summarized content, according to an embodiment of the present disclosure.

FIG. 8 is a flowchart showing a method by which a display device generates summarized content, according to an embodiment of the present disclosure.

FIG. 9 is a diagram showing an operating method based on an attention mechanism used when a display device generates summarized content, according to an embodiment of the present disclosure.

FIG. 10 is a diagram showing an example of a summarized content generation learning model, according to an embodiment of the present disclosure.

FIG. 11 is a diagram showing an example of an attention function according to an embodiment of the present disclosure.

FIG. 12 is a diagram showing an example of a state where a specific region is extracted from an actual image through an attention mechanism, according to an embodiment of the present disclosure.

FIG. 13 is a diagram showing a relationship between an attention and an LSTM hidden state, according to an embodiment of the present disclosure.

FIG. 14 is a flowchart showing a method by which a display device recommends summarized content based on a user input of changing a channel, according to a first embodiment of the present disclosure.

FIG. 15 is a flowchart showing a method by which a display device recommends summarized content based on a user input of changing a channel, according to a second embodiment of the present disclosure.

### BEST MODE FOR CARRYING OUT THE INVENTION

Hereinafter, embodiments of the present disclosure will be described in detail with reference to the drawings. The suffixes “module” and “unit or portion” for components used in the following description are merely provided only for facilitation of preparing this specification, and thus they are not granted a specific meaning or function.

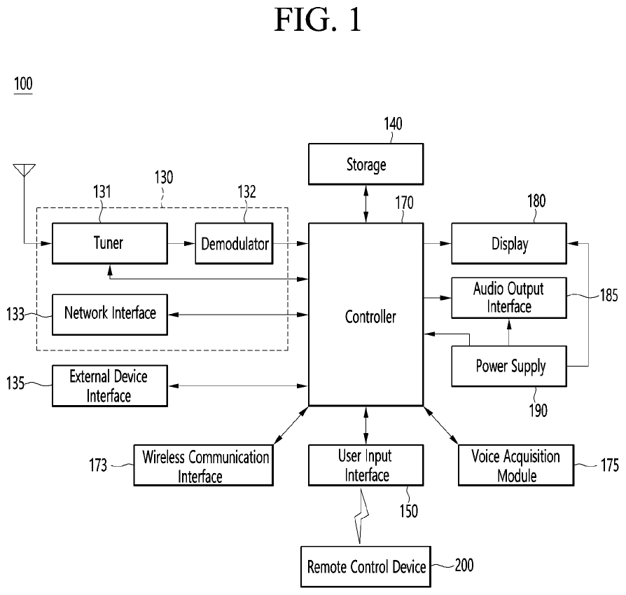

FIG. 1 is a block diagram illustrating a configuration of a display device according to an embodiment of the present disclosure.

Referring to FIG. 1, a display device 100 can include a broadcast reception module 130, an external device interface 135, a storage 140, a user input interface 150, a controller 170, a wireless communication interface 173, a voice acquisition module 175, a display 180, an audio output interface 185, and a power supply 190.

The broadcast reception module 130 can include a tuner 131, a demodulator 132, and a network interface 133.

The tuner 131 can select a specific broadcast channel according to a channel selection command. The tuner 131 can receive broadcast signals for the selected specific broadcast channel.

The demodulator 132 can divide the received broadcast signals into video signals, audio signals, and broadcast program related data signals and restore the divided video signals, audio signals, and data signals to an output available form.

The network interface 133 can provide an interface for connecting the display device 100 to a wired/wireless network including internet network. The network interface 133 can transmit or receive data to or from another user or another electronic device through an accessed network or another network linked to the accessed network.

The network interface 133 can access a predetermined webpage through an accessed network or another network linked to the accessed network. That is, it can transmit or receive data to or from a corresponding server by accessing a predetermined webpage through network.

Then, the network interface 133 can receive contents or data provided from a content provider or a network operator. That is, the network interface 133 can receive contents such as movies, advertisements, games, VODs, and broadcast signals, which are provided from a content provider or a network provider, through network and information relating thereto.

Additionally, the network interface 133 can receive firmware update information and update files provided from a network operator and transmit data to an internet or content provider or a network operator.

The network interface 133 can select and receive a desired application among applications open to the air, through network.

The external device interface 135 can receive an application or an application list in an adjacent external device and deliver it to the controller 170 or the storage 140.

The external device interface 135 can provide a connection path between the display device 100 and an external device. The external device interface 135 can receive at least one of image and audio outputted from an external device that is wirelessly or wiredly connected to the display device 100 and deliver it to the controller. The external device interface 135 can include a plurality of external input terminals. The plurality of external input terminals can include an RGB terminal, at least one High Definition Multimedia Interface (HDMI) terminal, and a component terminal.

An image signal of an external device inputted through the external device interface 135 can be outputted through the display 180. A sound signal of an external device inputted through the external device interface 135 can be outputted through the audio output interface 185.

An external device connectable to the external device interface 135 can be one of a set-top box, a Blu-ray player, a DVD player, a game console, a sound bar, a smartphone, a PC, a USB Memory, and a home theater system but this is just exemplary.

Additionally, some content data stored in the display device 100 can be transmitted to a user or an electronic device, which is selected from other users or other electronic devices pre-registered in the display device 100.

The storage 140 can store signal-processed image, voice, or data signals stored by a program in order for each signal processing and control in the controller 170.

Additionally, the storage 140 can perform a function for temporarily store image, voice, or data signals outputted from the external device interface 135 or the network interface 133 and can store information on a predetermined image through a channel memory function.

The storage 140 can store an application or an application list inputted from the external device interface 135 or the network interface 133.

The display device 100 can play content files (for example, video files, still image files, music files, document files, application files, and so on) stored in the storage 140 and provide them to a user.

The user input interface 150 can deliver signals inputted from a user to the controller 170 or deliver signals from the controller 170 to a user. For example, the user input interface 150 can receive or process control signals such as power on/off, channel selection, and screen setting from the remote control device 200 or transmit control signals from the controller 170 to the remote control device 200 according to various communication methods such as Bluetooth, Ultra Wideband (WB), ZigBee, Radio Frequency (RF), and IR.

Additionally, the user input interface 150 can deliver, to the controller 170, control signals inputted from local keys (not shown) such as a power key, a channel key, a volume key, and a setting key.

Image signals that are image-processed in the controller 170 can be inputted to the display 180 and displayed as an image corresponding to corresponding image signals. Additionally, image signals that are image-processed in the controller 170 can be inputted to an external output device through the external device interface 135.

Voice signals processed in the controller 170 can be outputted to the audio output interface 185. Additionally, voice signals processed in the controller 170 can be inputted to an external output device through the external device interface 135.

Besides that, the controller 170 can control overall operations in the display device 100.

Additionally, the controller 170 can control the display device 100 by a user command or internal program inputted through the user input interface 150 and download a desired application or application list into the display device 100 in access to network.

The controller 170 can output channel information selected by a user together with processed image or voice signals through the display 180 or the audio output interface 185.

Additionally, according to an external device image playback command received through the user input interface 150, the controller 170 can output image signals or voice signals of an external device such as a camera or a camcorder, which are inputted through the external device interface 135, through the display 180 or the audio output interface 185.

Moreover, the controller 170 can control the display 180 to display images and control broadcast images inputted through the tuner 131, external input images inputted through the external device interface 135, images inputted through the network interface, or images stored in the storage 140 to be displayed on the display 180. In this case, an image displayed on the display 180 can be a still image or video and also can be a 2D image or a 3D image.

Additionally, the controller 170 can play content stored in the display device 100, received broadcast content, and external input content inputted from the outside, and the content can be in various formats such as broadcast images, external input images, audio files, still images, accessed web screens, and document files.

Moreover, the wireless communication interface 173 can perform a wired or wireless communication with an external electronic device. The wireless communication interface 173 can perform short-range communication with an external device. For this, the wireless communication interface 173 can support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication interface 173 can support wireless communication between the display device 100 and a wireless communication system, between the display device 100 and another display device 100, or between networks including the display device 100 and another display device 100 (or an external server) through wireless area networks. The wireless area networks can be wireless personal area networks.

Herein, the other display device 100 can be a mobile terminal such as a wearable device (for example, a smart watch, a smart glass, and a head mounted display (HMD)) or a smartphone, which is capable of exchanging data (or inter-working) with the display device 100. The wireless communication interface 173 can detect (or recognize) a communicable wearable device around the display device 100. Furthermore, if the detected wearable device is a device authenticated to communicate with the display device 100, the controller 170 can transmit at least part of data processed in the display device 100 to the wearable device through the wireless communication interface 173. Accordingly, a user of the wearable device can use the data processed in the display device 100 through the wearable device.

The voice acquisition module 175 can acquire audio. The voice acquisition module 175 may include at least one microphone (not shown), and can acquire audio around the display device 100 through the microphone (not shown).

The display 180 can convert image signals, data signals, or OSD signals, which are processed in the controller 170, or images signals or data signals, which are received in the external device interface 135, into R, G, and B signals to generate driving signals.

Furthermore, the display device 100 shown in FIG. 1 is just one embodiment of the present disclosure and thus, some of the components shown can be integrated, added, or omitted according to the specification of the actually implemented display device 100.

That is, if necessary, two or more components can be integrated into one component or one component can be divided into two or more components and configured. Additionally, a function performed by each block is to describe an embodiment of the present disclosure and its specific operation or device does not limit the scope of the present disclosure.

According to another embodiment of the present disclosure, unlike FIG. 1, the display device 100 can receive images through the network interface 133 or the external device interface 135 and play them without including the tuner 131 and the demodulator 132.

For example, the display device 100 can be divided into an image processing device such as a set-top box for receiving broadcast signals or contents according to various network services and a content playback device for playing contents inputted from the image processing device.

In this case, an operating method of a display device according to an embodiment of the present disclosure described below can be performed by one of the display device described with reference to FIG. 1, an image processing device such as the separated set-top box, and a content playback device including the display 180 and the audio output interface 185.

The audio output interface 185 receives the audio processed signal from the controller 170 and outputs the sound.

The power supply 190 supplies the corresponding power throughout the display device 100. In particular, the power supply 190 supplies power to the controller 170 that can be implemented in the form of a System On Chip (SOC), a display 180 for displaying an image, and the audio output interface 185 for outputting audio or the like.

Specifically, the power supply 190 may include a converter for converting an AC power source into a DC power source, and a DC/DC converter for converting a level of the DC source power.

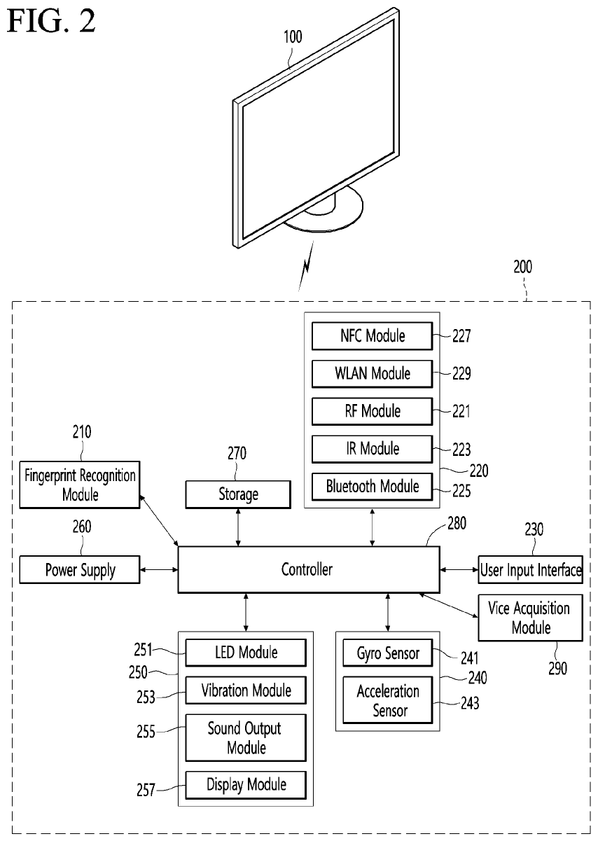

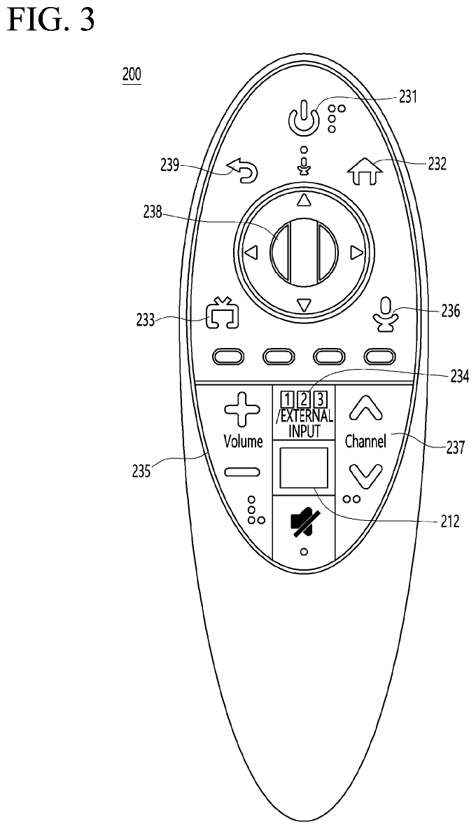

Then, referring to FIGS. 2 and 3, a remote control device is described according to an embodiment of the present disclosure.

FIG. 2 is a block diagram illustrating a remote control device according to an embodiment of the present disclosure and FIG. 3 is a view illustrating an actual configuration of a remote control device according to an embodiment of the present disclosure.

First, referring to FIG. 2, a remote control device 200 can include a fingerprint recognition module 210, a wireless communication interface 220, a user input interface 230, a sensor 240, an output interface 250, a power supply 260, a storage 270, a controller 280, and a voice acquisition module 290.

Referring to FIG. 2, the wireless communication interface 220 transmits/receives signals to/from an arbitrary any one of display devices according to the above-mentioned embodiments of the present disclosure.

The remote control device 200 can include an RF module 221 for transmitting/receiving signals to/from the display device 100 according to the RF communication standards and an IR module 223 for transmitting/receiving signals to/from the display device 100 according to the IR communication standards. Additionally, the remote control device 200 can include a Bluetooth module 225 for transmitting/receiving signals to/from the display device 100 according to the Bluetooth communication standards. Additionally, the remote control device 200 can include an NFC module 227 for transmitting/receiving signals to/from the display device 100 according to the Near Field Communication (NFC) communication standards and a WLAN module 229 for transmitting/receiving signals to/from the display device 100 according to the Wireless LAN (WLAN) communication standards

Additionally, the remote control device 200 can transmit signals containing information on a movement of the remote control device 200 to the display device 100 through the wireless communication interface 220.

Moreover, the remote control device 200 can receive signals transmitted from the display device 100 through the RF module 221 and if necessary, can transmit a command on power on/off, channel change, and volume change to the display device 100 through the IR module 223.

The user input interface 230 can be configured with a keypad button, a touch pad, or a touch screen. A user can manipulate the user input interface 230 to input a command relating to the display device 100 to the remote control device 200. If the user input interface 230 includes a hard key button, a user can input a command relating to the display device 100 to the remote control device 200 through the push operation of the hard key button. This will be described with reference to FIG. 3.

Referring to FIG. 3, the remote control device 200 can include a plurality of buttons. The plurality of buttons can include a fingerprint recognition button 212, a power button 231, a home button 232, a live button 233, an external input button 234, a voice adjustment button 235, a voice recognition button 236, a channel change button 237, a check button 238, and a back button 239.

The fingerprint recognition button 212 can be a button for recognizing a user's fingerprint. According to an embodiment of the present disclosure, the fingerprint recognition button 212 can perform a push operation and receive a push operation and a fingerprint recognition operation. The power button 231 can be button for turning on/off the power of the display device 100. The power button 231 can be button for moving to the home screen of the display device 100. The live button 233 can be a button for displaying live broadcast programs. The external input button 234 can be button for receiving an external input connected to the display device 100. The voice adjustment button 235 can be button for adjusting the size of a volume outputted from the display device 100. The voice recognition button 236 can be a button for receiving user's voice and recognizing the received voice. The channel change button 237 can be a button for receiving broadcast signals of a specific broadcast channel. The check button 238 can be a button for selecting a specific function and the back button 239 can be a button for returning to a previous screen.

Again, FIG. 2 is described.

If the user input interface 230 includes a touch screen, a user can touch a soft key of the touch screen to input a command relating to the display device 100 to the remote control device 200. Additionally, the user input interface 230 can include various kinds of input means manipulated by a user, for example, a scroll key and a jog key, and this embodiment does not limit the scope of the present disclosure.

The sensor 240 can include a gyro sensor 241 or an acceleration sensor 243 and the gyro sensor 241 can sense information on a movement of the remote control device 200.

For example, the gyro sensor 241 can sense information on an operation of the remote control device 200 on the basis of x, y, and z axes and the acceleration sensor 243 can sense information on a movement speed of the remote control device 200. Moreover, the remote control device 200 can further include a distance measurement sensor and sense a distance with respect to the display 180 of the display device 100.

The output interface 250 can output image or voice signals corresponding to a manipulation of the user input interface 230 or corresponding to signals transmitted from the display device 100. A user can recognize whether the user input interface 230 is manipulated or the display device 100 is controlled through the output interface 250.

For example, the output interface 250 can include an LED module 251 for flashing, a vibration module 253 for generating vibration, a sound output module 255 for outputting sound, or a display module 257 for outputting an image, if the user input interface 230 is manipulated or signals are transmitted/received to/from the display device 100 through the wireless communication interface 220.

Additionally, the power supply 260 supplies power to the remote control device 200 and if the remote control device 200 does not move for a predetermined time, stops the power supply, so that power waste can be reduced. The power supply 260 can resume the power supply if a predetermined key provided at the remote control device 200 is manipulated.

The storage 270 can store various kinds of programs and application data necessary for a control or operation of the remote control device 200. If the remote control device 200 transmits/receives signals wirelessly through the display device 100 and the RF module 221, the remote control device 200 and the display device 100 transmits/receives signals through a predetermined frequency band.

The controller 280 of the remote control device 200 can store, in the storage 270, information on a frequency band for transmitting/receiving signals to/from the display device 100 paired with the remote control device 200 and refer to it.

The controller 280 controls general matters relating to a control of the remote control device 200. The controller 280 can transmit a signal corresponding to a predetermined key manipulation of the user input interface 230 or a signal corresponding to a movement of the remote control device 200 sensed by the sensor 240 to the display device 100 through the wireless communication interface 220.

Additionally, the voice acquisition module 290 of the remote control device 200 can obtain voice.

The voice acquisition module 290 can include at least one microphone 291 and obtain voice through the microphone 291.

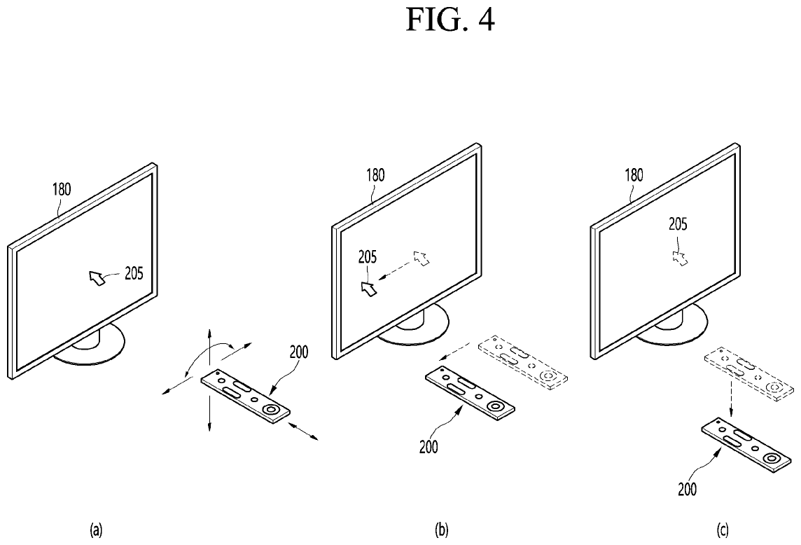

Then, FIG. 4 is described.

FIG. 4 is a view of utilizing a remote control device according to an embodiment of the present disclosure.

FIG. 4A illustrates that a pointer 205 corresponding to the remote control device 200 is displayed on the display 180.

A user can move or rotate the remote control device 200 vertically or horizontally. The pointer 205 displayed on the display 180 of the display device 100 corresponds to a movement of the remote control device 200. Since the corresponding pointer 205 is moved and displayed according to a movement on a 3D space as show in the drawing, the remote control device 200 can be referred to as a spatial remote controller.

FIG. 4B illustrates that if a user moves the remote control device 200, the pointer 205 displayed on the display 180 of the display device 100 is moved to the left in correspondence thereto.

Information on a movement of the remote control device 200 detected through a sensor of the remote control device 200 is transmitted to the display device 100. The display device 100 can calculate the coordinates of the pointer 205 from the information on the movement of the remote control device 200. The display device 100 can display the pointer 205 to match the calculated coordinates.

FIG. 4C illustrates that while a specific button in the remote control device 200 is pressed, a user moves the remote control device 200 away from the display 180. Thus, a selection area in the display 180 corresponding to the pointer 205 can be zoomed in and displayed largely.

On the other hand, if a user moves the remote control device 200 close to the display 180, a selection area in the display 180 corresponding to the pointer 205 can be zoomed out and displayed reduced.

On the other hand, if the remote control device 200 is away from the display 180, a selection area can be zoomed out and if the remote control device 200 is close to the display 180, a selection area can be zoomed in.

Additionally, if a specific button in the remote control device 200 is pressed, the recognition of a vertical or horizontal movement can be excluded. That is, if the remote control device 200 is moved away from or close to the display 180, the up, down, left, or right movement cannot be recognized and only the back and forth movement can be recognized. While a specific button in the remote control device 200 is not pressed, only the pointer 205 is moved according to the up, down, left or right movement of the remote control device 200.

Moreover, the moving speed or moving direction of the pointer 205 can correspond to the moving speed or moving direction of the remote control device 200.

Furthermore, a pointer in this specification means an object displayed on the display 180 in correspondence to an operation of the remote control device 200. Accordingly, besides an arrow form displayed as the pointer 205 in the drawing, various forms of objects are possible. For example, the above concept includes a point, a cursor, a prompt, and a thick outline. Then, the pointer 205 can be displayed in correspondence to one point of a horizontal axis and a vertical axis on the display 180 and also can be displayed in correspondence to a plurality of points such as a line and a surface.

On the other hand, the display device 100 according to an embodiment of the present disclosure recommends content in which the user may be interested among a variety of content provided on a broadcast or broadband basis, and may provide a summary of the recommended content.

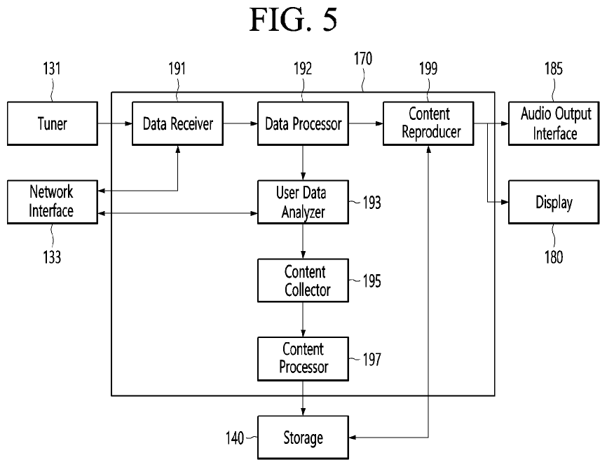

FIG. 5 is a block diagram showing a configuration for a display device to provide summarized content, according to an embodiment of the present disclosure.

The tuner 131 can receive a broadcast signal. That is, the tuner 131 can receive broadcast-based content.

The network interface 133 can provide an interface for connection to a wired/wireless network. The network interface 133 can receive wired/wireless network-based content, that is, broadband-based content.

The controller 170 can receive content from at least one of the tuner 131 or the network interface 133, and may generate summarized content obtained by summarizing the received content. The controller 170 can store the generated summarized content in the storage 140, and can output the generated summarized content through the audio output interface 185 and the display 180.

In more detail, the controller 170 can include at least some or all of a data receiver 191, a data processor 192, a user data analyzer 193, a content collector 195, a content processor 197, and a content reproducer 199. On the other hand, detailed components of the controller 170 are only examples for convenience of description, and some of the components can be omitted or other components can be further included.

The data receiver 191 can receive content from the tuner 131 or the network interface 133. The data receiver 191 can transmit the received content to the data processor 192.

The data processor 192 can receive content from the data receiver 191. The data processor 192 can extract metadata from the input content. For example, the data processor 192 can extract metadata, such as viewing time, genre, and characters, from the input content. That is, the data processor 192 can extract metadata required for user preference analysis from the content. The data processor 192 can transmit the extracted metadata to the user data analyzer 193.

The user data analyzer 193 can analyze user preference through metadata of content viewed by the user. The user data analyzer 193 can acquire the user preference by analyzing the metadata received from the data processor 192.

The user data analyzer 193 can extract information for selecting the user's favorite content by learning information about content that the user usually enjoys. That is, the user data analyzer 193 can extract information for acquiring the user's favorite content by learning information about all content viewed by the user.

In addition, the user data analyzer 193 can acquire the user's main viewing time zone. That is, the user data analyzer 193 can acquire viewing pattern information about content that the user mainly views and time zone during which the user views content.

The content collector 195 can collect content according to user preference. The content collector 195 can collect content according to the user preference acquired by the user data analyzer 193. That is, the content collector 195 can collect content corresponding to the user preference. The content collector 195 can receive content corresponding to the user preference through the tuner 131 or the network interface 133.

The content processor 197 can generate summarized content obtained by summarizing the content collected by the contents collector 195. That is, the content processor 197 can generate the summarized content by processing the content collected by the content collector 195.

The storage 140 can store the summarized content generated by the content processor 197. On the other hand, the summarized content can be stored in an edge cloud.

The edge cloud can be a server for content distribution processing of a content delivery network (CDN). Content providers can build and operate a cache server called a CDN. In order to reduce a load concentrated on a core cloud, the content is distributed and managed in the edge cloud.

The content reproducer 199 can configure resources for reproduction of content, in particular, summarized content. Specifically, the content reproducer 199 can generate a pipeline for reproducing the summarized content, can designate a codec, and the like.

The content reproducer 199 can transmit summarized content data to the audio output interface 185 and the display 180 so that the summarized content is output.

The audio output interface 185 and the display 180 can output the summarized content based on the received summarized content data.

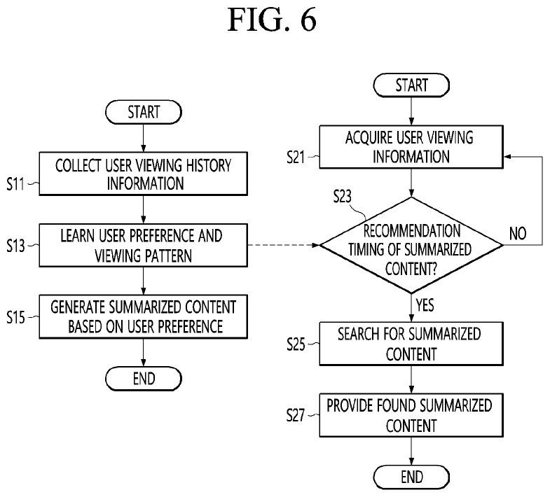

FIG. 6 is a flowchart showing a method by which a display device provides summarized content, according to an embodiment of the present disclosure.

The controller 170 can collect user viewing history information (S11).

The user viewing history information can refer to information about content that the user has viewed so far. For example, the user viewing history information can include viewing time and viewing content (including metadata).

That is, the controller 170 can collect information about content viewed by the user in order to analyze the user preference and the viewing pattern.

The controller 170 can learn the user preference and the viewing pattern (S13).

The controller 170 can learn the user preference and the viewing pattern based on the user viewing history information. Accordingly, the controller 170 can acquire the user preference and the viewing pattern, respectively.

According to an embodiment, the controller 170 can update the user preference and the viewing pattern whenever the user viewing history information is acquired.

The user preference can include a genre of content frequently viewed by the user. For example, the controller 170 can classify and count genres of content viewed by the user, and can acquire the top three genres as the user preference.

The viewing pattern can include the time zone during which the user views the content. In more detail, the viewing pattern can include a viewing zone for each genre of content. For example, the controller 170 can acquire the viewing pattern such as a content viewing time zone of a first genre a first time zone and a content viewing time of a second genre as a second time zone.

The controller 170 can generate summarized content based on the user preference (S15).

The controller 170 can collect content of interest based on the user preference.

The controller 170 can acquire the user's favorite content based on the user preference, and can generate summarized content of the acquired content. The controller 170 can extract some frames from original content based on the user preference, and can generate summarized content including the extracted frames. Here, the original content can be content including all frames omitted before being summarized as the summarized content.

That is, operation S15 can be an operation of processing the original content. The controller 170 can generate user-customized summarized content based on the user viewing history information. Specifically, the controller 170 can summarize the original content to the user's favorite length (total reproduction time), and can reflect the user preference in the summarization process. For example, when an action genre is acquired as the user preference, the controller 170 can generate summarized content having a higher ratio of action scenes than other scenes.

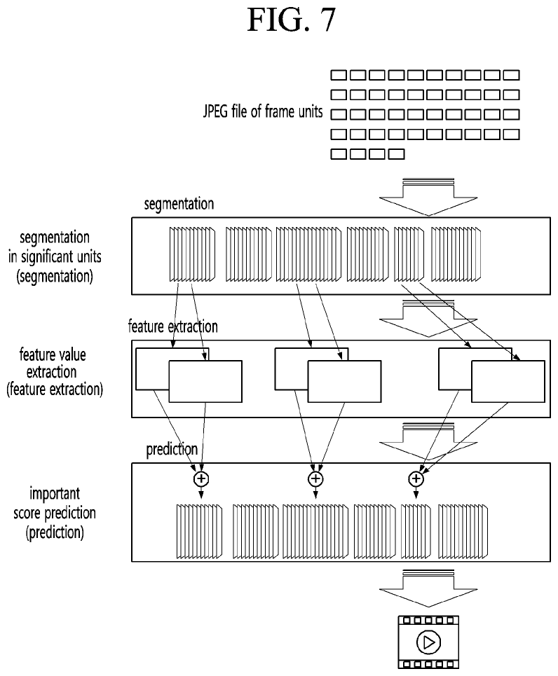

The controller 170 can extract a frame to be included in the summarized content from the original content based on an attention mechanism. A method for generating summarized content will be described in more detail with reference to FIGS. 7 to 13.

As described above, the controller 170 can generate summarized content in advance. In addition, the controller 170 can periodically collect user viewing history information and update the user preference and the viewing pattern. The controller 170 can periodically generate and update the summarized content.

The controller 170 can acquire user viewing information (S21).

The user viewing information can refer to information about a current viewing state of the user. For example, the user viewing information can include input information of the remote control device 200, information about a channel being viewed, information about content being viewed, and the like.

The controller 170 can determine whether it is a recommendation timing of the summarized content, based on the user viewing information (S23).

The controller 170 can determine whether to recommend the summarized content, based on the user viewing information. That is, the controller 170 can determine whether it is a timing to recommend the summarized content, based on the user viewing information.

The controller 170 can use a model learning the user preference and the viewing pattern in order to determine the recommendation timing of the summarized content. That is, the controller 170 can determine whether it is the recommendation timing of the summarized content by using the model learning the user preference and the viewing pattern.

According to an embodiment, when the content displayed on the channel changed according to the user input is the user's favorite content, the controller 170 can recognize the recommendation timing of the summarized content and can recommend the summarized content.

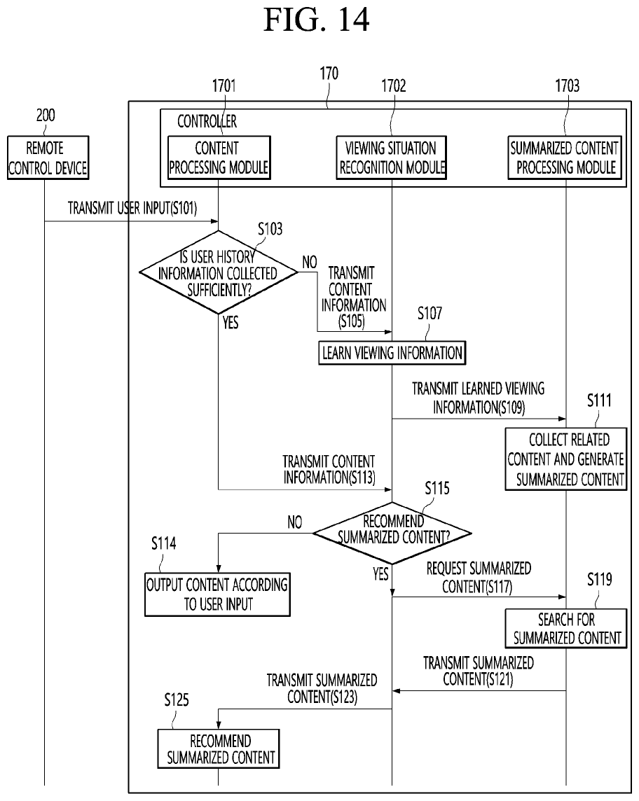

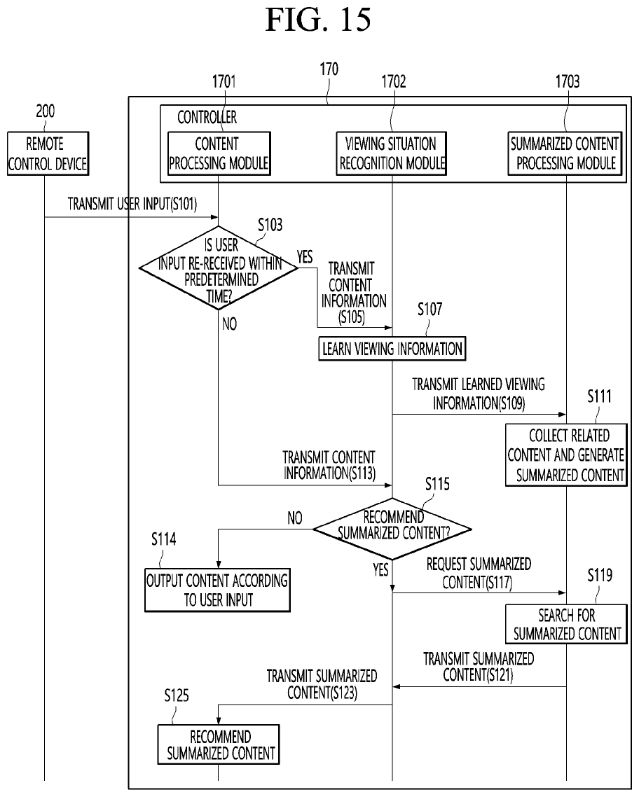

According to another embodiment, the controller 170 can recognize the user viewing situation and can determine whether it is a recommendation timing of the summarized content, based on the user viewing situation. That is, since the recommendation timing (viewpoint) is different depending on the type (for example, genre) of content, the controller 170 can determine whether it is a recommendation timing of the summarized content by acquiring the current viewing situation of the user, based on the user viewing information. For example, the controller 170 can determine whether the recommendation timing of the summarized content is based on the user input of changing the channel, and this will be described in detail with reference to FIGS. 14 and 15.

When it is determined that it is not the recommendation timing, the controller 170 can continuously acquire user viewing information.

The controller 170 can search for the summarized content when it is determined as the recommendation timing (S25).

When it is determined as the recommendation timing, the controller 170 can search for summarized content to be recommended, based on the user viewing information. The controller 170 can search for summarized content to be recommended from the summarized content stored in the storage 140 or the summarized content stored in the edge cloud (not shown).

According to an embodiment, when the summarized content is not found, the controller 170 can generate summarized content to be recommended.

The controller 170 can provide the found summarized content (S27).

The controller 170 can directly output the found summarized content, or can display a screen for recommending the found summarized content in order to confirm whether to recommend the found summarized content.

In this manner, the controller 170 can control the display 180 to display the summarized content generated based on the user preference. On the other hand, the summarized content can be content including some frames extracted based on the user preference in the original content.

On the other hand, when the user views the provided summarized content, the controller 170 can use the information about the viewed summarized content again in operation S13. That is, when learning the user preference and the viewing pattern, the controller 170 can use information about the summarized content viewed by the user. The controller 170 can update the user preference based on whether the user views the summarized content. Accordingly, there is an advantage that the controller 170 can learn the user preference more accurately.

Next, a method for generating summarized content will be described in detail with reference to FIGS. 7 to 13.

FIG. 7 is a diagram schematically showing a technology by which a display device generates summarized content, according to an embodiment of the present disclosure.

The controller 170 can generate summarized content including only scenes of interest of the user by combining artificial intelligence technology and computer vision technology. In particular, the controller 170 can apply an attention mechanism to generate summarized content by extracting a highlight scene based on a deep neural network (DNN).

Referring to FIG. 7, the controller 170 can analyze content in frame units to segment the frames into predetermined units.

The controller 170 can perform feature extraction for each segmented unit.

The controller 170 can predict an important score for each extracted feature value.

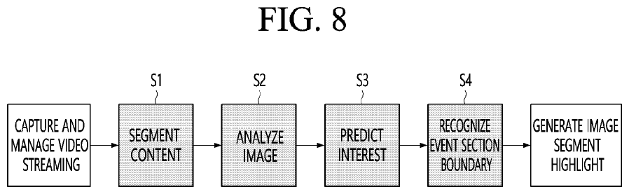

FIG. 8 is a flowchart showing a method by which a display device generates summarized content, according to an embodiment of the present disclosure.

The controller 170 can capture and manage video streaming when not generating summarized content.

The controller 170 can segment the content when the generation of the summarized content is started (S1).

The controller 170 can segment the content into frame units for image analysis for each frame as a process of pre-processing target content corresponding to the original of the summarized content.

In addition, the controller 170 can detect a scene change in the content segmentation process or can measure a magnitude of a motion in the scene.

After segmenting the content, the controller 170 can perform image analysis (S2).

The controller 170 can detect a person and a specific scene as a main viewpoint in generating the summarized content.

The controller 170 can use an attention mechanism during image analysis.

The controller 170 can perform an interest prediction after performing the image analysis (S3).

The controller 170 can calculate an interest index for the detected person or specific scene, can extract an optimal weight, and can quantitatively extract the importance of a corresponding frame.

The controller 170 can recognize an event section boundary (S4).

For example, the controller 170 can recognize the boundary of the section in which an event occurs, such as a change of place or a change of person. The controller 170 can accurately find a significant feature value for object recognition through the event section boundary recognition. That is, the controller 170 can recognize an importance scene through temporal and spatial analysis, can predict an interest index using a linear combination of feature values, and can generate summarized content while deleting a segmented image having a low interest index.

The controller 170 can generate summarized content (highlight) by concatenating the segmented images remaining after deletion.

In summary, the controller 170 can segment the frame of the original content into predetermined units, can extract a feature value for each segmented unit, can predict an importance score for the extracted feature value, and can extract a frame to be included in the summarized content. The controller 170 can generate summarized content by concatenating the extracted frames. On the other hand, the controller 170 can extract a feature value according to whether an event occurs in each segmented unit. For example, the controller 170 can extract a high or low feature value according to whether an event occurs. Measuring a feature value to be high or low according to whether an event occurs may vary depending on the genre of the content. The controller 170 can acquire detect a changes in person, space, and time to acquire whether an event has occurred. That is, when the person, space, and time change, the controller 170 can detect that an event has occurred.

In this way, the generation of the summarized content may include four operations: content segmentation, image analysis, interest prediction, and event section boundary recognition.

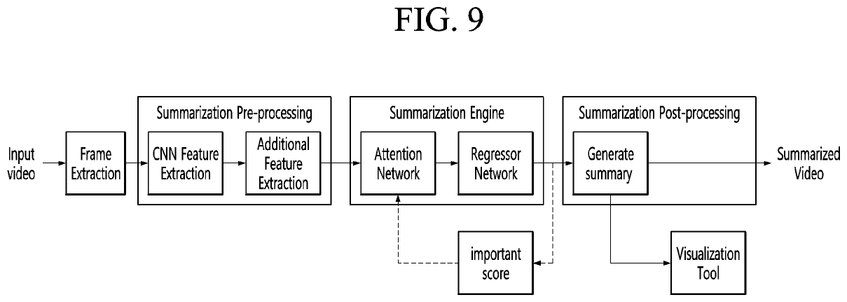

FIG. 9 is a diagram showing an operating method based on an attention mechanism used when a display device generates summarized content, according to an embodiment of the present disclosure.

The controller 170 can include a summarization pre-processing module 1971, a summarization engine module 1973, and a summarization post-processing module 1975.

In particular, each of the summarization pre-processing module 1971, the summarization engine module 1973, and the summarization post-processing module 1975 can be one configuration of the content processor 197 of the controller 170, but this is only an example, and it is appropriate that the present disclosure is not limited thereto.

The summarization pre-processing module 1971 can extract the frame of the target content, that is, the input image. That is, the summarization pre-processing module 1971 can extract a processing unit from the input image in frame units.

The summarization pre-processing module 1971 can utilize a CNN-based model in order to extract features for generating summarized content including only key frames with high importance. The summarization pre-processing module 1971 can extract features for generating the summarized content.

Also, the summarization pre-processing module 1971 can recognize an event occurrence time in order to obtain a scene change section.

The summarization pre-processing module 1971 can transmit the extracted features and the event occurrence time to the summarization engine module 1973.

The summarization engine module 1973 can apply an attention scheme to extract a key frame by predicting an importance score in frame units. That is, the summarization engine module 1973 can predict the importance score for each frame based on the extracted features and the event occurrence time, and can extract a key frame based on the predicted importance score. For example, the summarization engine module 1973 can extract a frame having an importance score higher than a threshold as the key frame.

That is, the summarization engine module 1973 can perform an inference operation through a model trained based on a labeled dataset.

The summarization post-processing module 1975 can generate summarized content (summarized video) including the key frames.

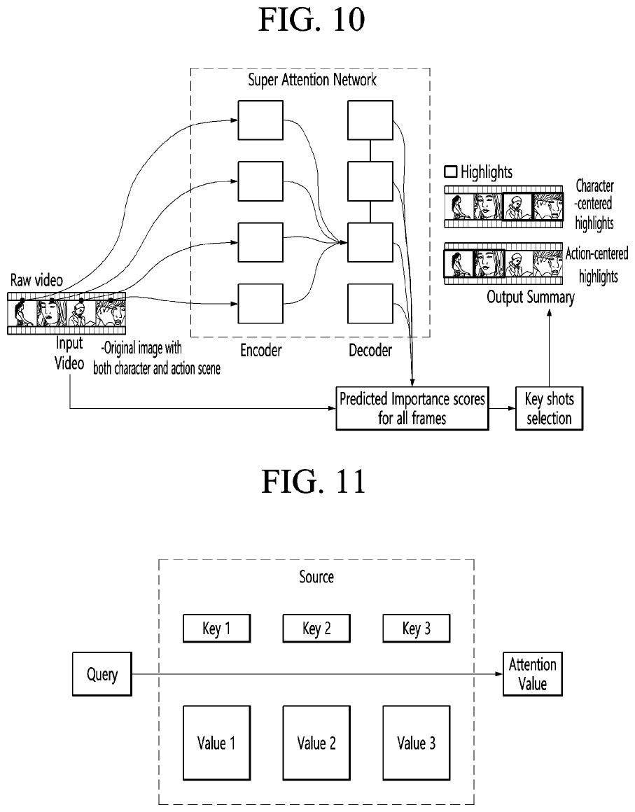

FIG. 10 is a diagram showing an example of the summarized content generation learning model, according to an embodiment of the present disclosure.

The summarized content generation learning model can be a learning model to which an encoder-decoder architecture style is applied.

In the summarized content generation learning model according to an embodiment of the present disclosure, the attention mechanism can include an encoder and a decoder.

The encoder can continuously receive frames, can output a context vector, to which a weight is reflected, as a result, and can predict an importance score for selecting a frame to be included in the summarized content.

The decoder can receive the context vector, to which the weight is reflected, from the encoder. The decoder can intensively train a region to select key shots according to the context vector. Here, the shot can be a set of consecutive frames, and the key shot can be a set of consecutive frames to be included in the summarized content.

The controller 170 can refer to the entire frame once again in the encoder at every time step in which the decoder predicts the output frame by applying the attention mechanism. In particular, the controller 170 does not refer to all input frames at the same rate, but can check input frames associated with the frame to be predicted at the corresponding time step again.

In the attention mechanism, a function can be formed as a data type including the key value.

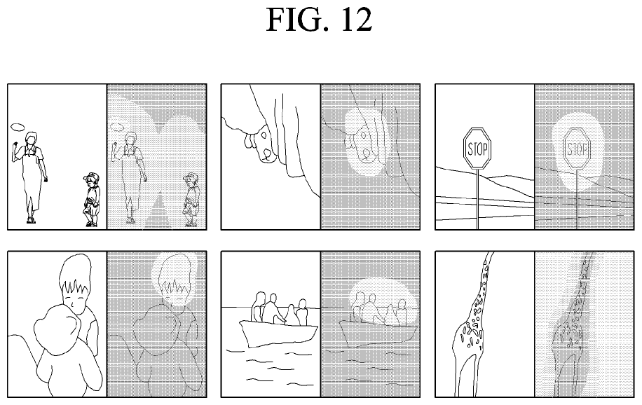

FIG. 11 is a diagram showing an example of an attention function according to an embodiment of the present disclosure.

The attention function can be a dictionary data type, which is a data type including the key value. The attention function includes a pair of a key and a value, and thus, a mapped value can be found through the key.

The controller 170 can acquire an attention value through the attention function.

Through the attention function, the encoder acquires only a partial region that influences the result, not the entire region of the image, and the decoder processes only the acquired partial region. Therefore, there is an advantage in that efficient image processing is possible.

FIG. 12 is a diagram showing an example of a state where a specific region is extracted from an actual image through an attention mechanism, according to an embodiment of the present disclosure.

Referring to the example of FIG. 12, an image in which an original frame and a region extracted with attention from the original frame for each of example frames are brightly displayed is shown. That is, the method by which the controller 170 extracts a frame including a region such as a person, an animal, and a sign, that is, a region extracted by attention, through the attention mechanism can be confirmed with reference to the example of FIG. 12.

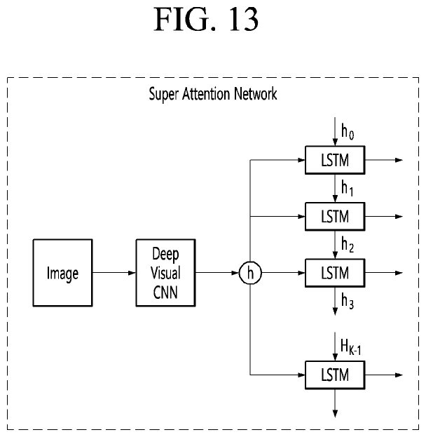

FIG. 13 is a diagram showing a relationship between an attention and an LSTM hidden state, according to an embodiment of the present disclosure.

The controller 170 can extract features from each frame extracted from the target content through the CNN network, and the extracted features may affect the LSTM with the hidden states of h₀, h₁, . . . , hₖ₋₁ divided into k parts by an attention influence h.

The controller 170 can receive a frame sequence and predict an importance score for selecting a frame to be included in the summarized content through the CNN network. The controller 170 can intensively learn a region for selecting a key shot in the LSTM for which a weight is calculated based on the predicted importance score.

The controller 170 can generate the summarized content by concatenating the key shots acquired by the above-described method in the final stage of the decoder.

On the other hand, the display device 100 according to an embodiment of the present disclosure may recommend summarized content generated by recognizing a user viewing situation.

According to an embodiment, the controller 170 can train a user viewing situation recognition model.

Specifically, in operation S13 of FIG. 6, the controller 170 can acquire the user viewing situation recognition model by learning the user preference and the viewing pattern. Accordingly, the controller 170 can recognize the channel change time and can recommend the summarized content based on content information of the changed channel.

When the channel changed through the pre-trained model is a user's favorite content, the controller 170 can recommend summarized content of the corresponding content. The controller 170 can recommend summarized content of the same content as the content of the changed channel, content with the same genre as the content of the changed channel, content with the same person as the content of the changed channel, and the like.

For example, when eight baseball games of team A and team B are being broadcast on the changed channel, the controller 170 can recommend summarized contents for broadcasts of episodes 1 to 7 corresponding to the previous episode.

As another example, when the second half of a soccer game between country A and country B is being broadcast on the changed channel, the controller 170 can recommend summarized content for the previous first half broadcast.

As another example, when news is being broadcast on the changed channel, the controller 170 can recommend summarized content for the latest news.

As another example, when a drama is being broadcast on the changed channel, the controller 170 can recommend summarized content for a previous episode of the corresponding broadcast. That is, when the episode 12 of a drama A is being broadcast on the changed channel, the controller 170 can recommend summarized content acquired by summarizing episodes 1 to 11.

According to another embodiment, the controller 170 can recommend the summarized content based on the user input of changing the channel.

FIG. 14 is a flowchart showing a method by which the display device recommends summarized content based on the user input of changing the channel, according to a first embodiment of the present disclosure.

In FIG. 14, the controller 170 is divided into a content processing module 1701, a viewing situation recognition module 1702, and a summarized content processing module 1703, but this is only for convenience of description, and it is apparent that the present disclosure is not limited thereto.

The controller 170 can receive a user input from the remote control device 200 (S101).

The user input can be an input for changing a channel. For example, the user input can be a channel up/down input or a channel number input.

When receiving the user input, the content processing module 1701 can determine whether user history information has been sufficiently collected (S103).

That is, the controller 170 can acquire the recommendation timing of the summarized content according to whether the user history information necessary for acquiring the user preference is stored in the storage 140 in a predetermined reference size or more.

Specifically, the content processing module 1701 can determine whether the user history information is stored in the storage 140 in a size equal to or greater than a preset reference size. When the size of the user history information stored in the storage 140 is greater than or equal to the preset reference size, the content processing module 1701 can determine that the user history information has been sufficiently collected, and when the size of the user history information stored in the storage 140 is less than the preset reference size, the content processing module 1701 can determine that the user history information has not been sufficiently collected.

On the other hand, the controller 170 can determine for each user whether the user history information has been sufficiently collected. The display device 100 can include a camera (not shown) for distinguishing the currently viewing user. The display device 100 can classify user history information for each user and can store the user history information in the storage 140. Accordingly, the controller 170 can recognize the user currently viewing the content and can determine whether user history information for the user currently viewing the content has been sufficiently collected.

When the user history information is not sufficiently collected, the content processing module 1701 can transmit content information to the viewing situation recognition module 1702 (S105).

The viewing situation recognition module 1702 can learn viewing information based on the received content information (S107).

The viewing situation recognition module 1702 can transmit the learned viewing information to the summarized content processing module 1703 (S109).

The summarized content processing module 1703 can collect related content and generate summarized content, based on the learned viewing information (S111).

That is, the summarized content processing module 1703 can collect related content supposed as the user's favorite content based on the learned viewing information, and can generate summarized content by summarizing the collected related content.

On the other hand, when the content processing module 1701 has sufficiently collected the user history information, the content processing module 1701 can transmit the content information to the viewing situation recognition module 1702 (S113).

That is, when the user history information has been sufficiently collected, the content processing module 1701 can transmit content information to the viewing situation recognition module 1702 in order to provide summarized content according to the content of the channel changed according to the user input.

When receiving the content information, the viewing situation recognition module 1702 can determine whether to recommend the summarized content (S115).

The viewing situation recognition module 1702 can determine whether to recommend the summarized content based on the received content information.

For example, the viewing situation recognition module 1702 can determine whether the summarized content according to the received content information is stored or whether the generation of the summarized content according to the received content information is possible. The viewing situation recognition module 1702 can determine to recommend the summarized content when the summarized content is stored or the generation of the summarized content is possible.

When the viewing situation recognition module 1702 determines not to recommend the summarized content, the viewing situation recognition module 1702 can output the content according to the user input (S114).

When the viewing situation recognition module 1702 determines to recommend the summarized content, the viewing situation recognition module 1702 can request the summarized content from the summarized content processing module 1703 (S117).

When the summarized content processing module 1703 receives the request for the summarized content, the summarized content processing module 1703 can search for the summarized content (S119).

The summarized content processing module 1703 can search for the summarized content based on the content information (S119).

According to an embodiment, when there is no summarized content pre-stored in the storage 140, the summarized content processing module 1703 can generate the summarized content according to the content information.

On the other hand, the controller 170 can recommend summarized content associated with content displayed on the channel changed according to the user input. When a sports game is being broadcast on the changed channel, the controller 170 can recommend summarized content acquired by summarizing previous content of the sports game being broadcast. For example, when the second half of the soccer game is being broadcast on the changed channel, the controller 170 can recommend summarized content acquired by summarizing the first half of the soccer game. When news is being broadcast on the changed channel, the controller 170 can recommend summarized content acquired by summarizing the latest news. The controller 170 can recommend summarized content of the same content as the content of the changed channel, content with the same genre as the content of the changed channel, or content with the same person as the content of the changed channel,

The summarized content processing module 1703 can transmit the summarized content to the viewing situation recognition module 1702 (S121).

The viewing situation recognition module 1702 can transmit the summarized content received from the summarized content processing module 1703 to the content processing module 1701 (S123).

The content processing module 1701 can recommend the received summarized content (S125).

FIG. 15 is a flowchart showing a method by which a display device recommends summarized content based on a user input of changing a channel, according to a second embodiment of the present disclosure.

The method for recommending summarized content according to FIG. 15, that is, the method for recommending summarized content according to the second embodiment may differ from the method for recommending summarized content according to FIG. 14 (the method for recommending summarized content according to the first embodiment) in terms of only operation S103. Therefore, a redundant description will be omitted, and operation S103 will be described in detail.

When receiving the user input, the content processing module 1701 can determine whether the user input is re-received within a predetermined time (S103).

That is, when the user input is re-received within a predetermined time after receiving the user input, the controller 170 can recommend the summarized content.

Specifically, when the content processing module 1701 receives the user input, the content processing module 1701 can count the time until the next user input is received. The content processing module 1701 can compare the counted time with the predetermined time to determine whether the user input is re-received within the predetermined time.

When the content processing module 1701 determines that the user input has been re-received within the predetermined time, the content processing module 1701 can determine that the user cannot find the content to view, and can recommend the summarized content. Accordingly, when the content processing module 1701 determines that the user input has been re-received within the predetermined time, the content processing module 1701 can transmit the content information to the viewing situation recognition module 1702, and the viewing situation recognition module 1702 can determine whether to recommend the summarized content is recommended, and can recommend the summarized content.

On the other hand, when the content processing module 1701 determines that the user input has not been re-received within the predetermined time, the content processing module 1701 can determine that the user is viewing content according to the user input and thus, may not recommend the summarized content. Instead, when the content processing module 1701 determines that the user input has not been re-received within the predetermined time, the content processing module 1701 can transmit information about the content being viewed by the user, can learn the viewing information, and can generate summarized content.

In summary, in operation S103 of each of FIGS. 14 and 15, when the summarized content is not recommended, the controller 170 can learn user preference based on information about content displayed according to the user input.

The above description is merely illustrative of the technical idea of the present disclosure, and various modifications and changes may be made thereto by those skilled in the art without departing from the essential characteristics of the present disclosure.

Therefore, the embodiments of the present disclosure are not intended to limit the technical spirit of the present disclosure but to illustrate the technical idea of the present disclosure, and the technical spirit of the present disclosure is not limited by these embodiments.

The scope of protection of the present disclosure should be interpreted by the appending claims, and all technical ideas within the scope of equivalents should be construed as falling within the scope of the present disclosure.

1. A display device comprising:
a controller configured to acquire user preference; and
a display configured to display summarized content generated based on the user preference,
wherein the controller is configured to extract some frames from original content based on the user preference, and to generate summarized content including the extracted frames.

2. The display device of claim 1, wherein, when the controller receives a user input of changing a channel, the controller is configured to acquire a recommendation timing of the summarized content based on the user input.

3. The display device of claim 2, wherein, when content displayed on the channel changed according to the user input is a user's favorite content, the controller is configured to recommend the summarized content.

4. The display device of claim 2, wherein the controller is configured to recommend summarized content associated with content displayed on the channel changed according to the user input.

5. The display device of claim 4, wherein, when a sports game is being broadcast on the changed channel, the controller is configured to recommend summarized content acquired by summarizing previous content of the sports game being broadcast.

6. The display device of claim 4, wherein, when news is being broadcast on the changed channel, the controller is configured to recommend summarized content acquired by summarizing latest news.

7. The display device of claim 4, wherein the controller is configured to recommend summarized content of the same content as the content displayed on the changed channel, content with the same genre as the content displayed on the changed channel, or content with the same person as the content displayed on the changed channel.

8. The display device of claim 2, wherein, when the user input is re-received within a predetermined time after receiving the user input, the controller is configured to recommend the summarized content.

9. The display device of claim 2, wherein the controller is configured to acquire the recommendation timing according to whether user history information necessary for acquiring the user preference is stored in a storage in a predetermined reference size or more.

10. The display device of claim 2, wherein, when the controller does not recommend the summarized content, the controller is configured to learn the user preference based on information about content displayed according to the user input.

11. The display device of claim 1, wherein the controller is configured to update the user preference based on whether the user views the summarized content.

12. The display device of claim 1, wherein the controller is configured to extract a frame to be included in the summarized content from the original content based on an attention mechanism.

13. The display device of claim 12, wherein the controller is configured to segment a frame of the original content into predetermined units, to extract a feature value for each segmented unit, to predict an importance score for the extracted feature value, and to extract the frame to be included in the summarized content.

14. The display device of claim 13, wherein the controller is configured to extract the feature value according to whether an event occurs in each segmented unit.

15. The display device of claim 14, wherein the controller is configured to detect a change in person, space or time to acquire whether the event occurs.
